(19) United States
(12) Patent Application Publication
(10) Pub. No.: US 2003/0023481 A1
(43) Pub. Date: Jan. 30, 2003

(54) Method of selecting an internet advertisement to be served to a user

(76) Inventors: Sarah Calvert, Seattle, WA (US); Chen Yu, Mountain View, CA (US)

Correspondence Address: BENNET K. LANGLOTZ, P. C., BOX 759, GENOA,, NV, 89411, US

(21) Appl. No.: 09/912,475

(22) Filed: Jul. 24, 2001

(51) Int. Cl. G06F 17/60

(52) U.S. Cl. 705/14

(57) ABSTRACT

A method of serving Internet advertisements to users having associated cookies includes receiving a cookie from a user visiting a publisher, then retrieving a database record of past Internet activity associated with the cookie. Based on the record, is it determined whether the cookie is associated with past interactions with any of the advertisers. If the cookie has had interactions with multiple advertisers, an advertisement associated with the advertiser with the greatest level of desired attributes is served. If there are no past interactions, past web activity of the cookie is analyzed to determine the advertiser with the best prospects for success.

This invention relates to commercial internet communication, and more particularly to evaluation of commercial and advertising communication.

### BACKGROUND AND SUMMARY OF THE INVENTION

The Internet is an effective tool for commercial communication. Companies use electronic communications to consumers to cost-effectively promote their goods or services. Normally, an Advertising Service Company (ASC) contracts with web publishers with advertising space, and with advertisers. Advertisements for the advertisers are placed on the publisher's sites, to be viewed by users while visiting those sites. Each time a use visits, a unique identifier (e.g. cookie) associated e) sowith the computer or other device employed by the user is collected by the advertising service company, and information about the visit stored in the company's database. The collected information does not identify the user, so privacy is protected, yet is useful to correlate past activity associated with the uniquely identified cookie.

An advertising service company normally places ads from a number of different advertisers, and contracts with a number of different publishers for advertising space. This service saves the advertisers the inconvenience and impracticality of placing advertisements with a multitude of different publishers, much as conventional advertising agencies arrange for various advertising purchases on behalf of a number of different advertiser clients.

The ASC may purchase advertising space on behalf of advertisers at particular publishers believed suited to the advertiser's target market. However, an ASC may provide additional value if it leaves advertising assignments more flexible. For instance, instead of pushing a particular advertiser's ad to all visitors at a site, or delivering a rotation of several different advertiser's advertisement, the ASC may use attributes of the cookie to determine which advertiser will receive the ad impression. This decision is made on the basis of cookie membership in a specified list. If it is on more than one advertiser's list, a random choice must be made, leading to lost opportunities when the user was a much better prospect for one advertiser than for the other. Similarly, if the cookie is on no advertisers' lists, then the random assignment of an ad wastes a potential opportunity to deliver an ad suited to the user.

The present invention overcomes the limitations of the prior art by providing a method of serving Internet advertisements to users having associated cookies. The method includes receiving a cookie from a user visiting a publisher, then retrieving a database record of past Internet activity associated with the cookie. Based on the record, is it determined whether the cookie has attributes desired by various advertisers (e.g. specified interest, high likelihood to purchase, past customer, etc.) If the cookie has the desired attributes with multiple advertisers, an advertisement associated with the advertiser with the greatest level of desired attributes is served. If there are no past interactions, past web activity of the cookie is analyzed to determine the advertiser with the best prospects for success.

### BRIEF DESCRIPTION OF THE DRAWINGS

FIG. 1 is a schematic block diagram showing the system and method of operation according to a preferred embodiment of the invention.

FIG. 2 is a schematic block diagram showing a sample test protocol according to a preferred embodiment of the invention.

### DETAILED DESCRIPTION OF A PREFERRED EMBODIMENT

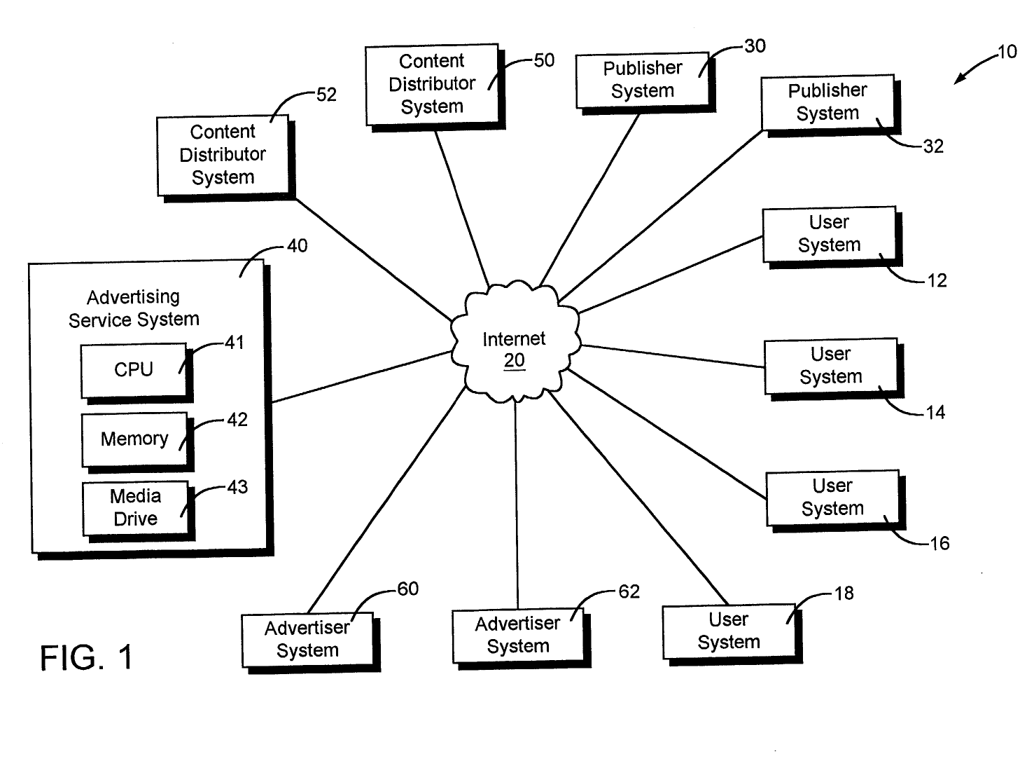

FIG. 1 is a high-level block diagram showing the environment and facility 10 in which the method preferably operates. The diagram shows a number of Internet customer or user computer systems 12, 14, 16, 18. An Internet customer preferably uses one such Internet customer computer system to connect, via the Internet 20, to an Internet publisher computer system, such as Internet publisher computer systems 30 and 32, to retrieve and display a Web page. Although discussed in terms of the Internet, this disclosure and the claims that follow use the term “Internet” to include not just personal computers, but all other electronic devices having the capability to interface with the Internet or other computer networks, including portable computers, telephones, televisions, appliances, electronic kiosks, and personal data assistants, whether connected by telephone, cable, optical means, or other wired or wireless modes including but not limited to cellular, satellite, and other long and short range modes for communication over long distances or within limited areas and facilities.

In cases where an Internet advertiser, through the Internet advertising service company, has purchased advertising space on the Web page provided to the Internet customer computer system by the Internet publisher computer system, the Web page contains a reference to a URL in the domain of the Internet Advertising Service Company (ASC) computer system 40. When a customer computer system receives a Web page that contains such a reference, the Internet customer computer systems sends a request to the Internet advertising service computer system to return data comprising an advertising message, such as a banner advertising message. When the Internet advertising service computer system receives such a request, it selects an advertising message to transmit to the Internet customer computer system in response the request. Then, it either transmits the selected advertising message itself, or redirects the request containing an identification of the selected advertising message to an Internet content distributor computer system, such as Internet content distributor computer systems 50 and 52. When the Internet customer computer system receives the selected advertising message, the Internet customer computer system displays it within the Web page. The Internet advertising service is not limited to banner advertisements, which are used as an example. Other Internet advertising modes include email messages directed to a user who has provided his or her email address in a request for such messages.

The displayed advertising message preferably includes one or more links to Web pages of the Internet advertiser's Web site. When the Internet customer selects one of these links in the advertising message, the Internet customer computer system de-references the link to retrieve the Web page from the appropriate Internet advertiser computer system, such as Internet advertiser computer system 60 or 62. In visiting the Internet advertiser's Web site, the Internet customer may traverse several pages, and may take such actions as purchasing an item or bidding in an auction.

The Internet advertising service computer system 40 preferably includes one or more central processing units (CPUs) 41 for executing computer programs such as the facility, a computer memory 42 for storing programs and data, and a computer-readable media drive 43, such as a CD-ROM drive, for reading programs and data stored on a computer-readable medium.

While preferred embodiments are described in terms of the environment described above, those skilled in the art will appreciate that the facility may be implemented in a variety of other environments, including a single, monolithic computer system, as well as various other combinations of computer systems or similar devices.

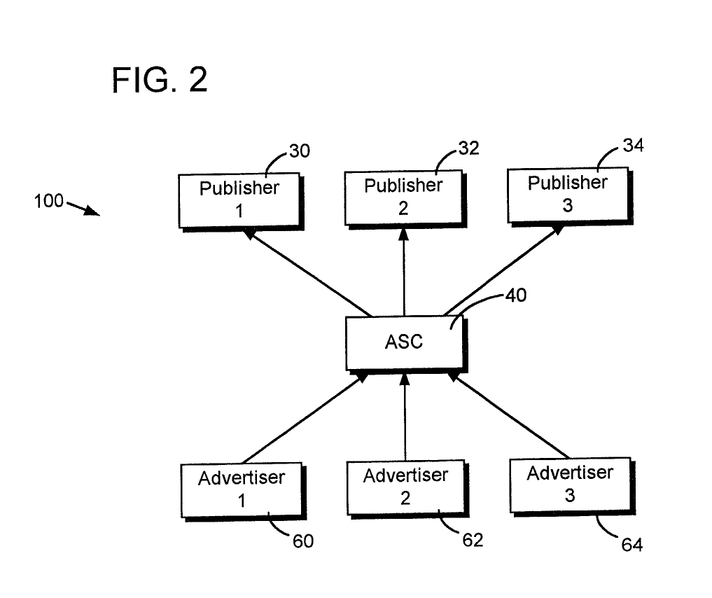

FIG. 2 shows a schematic representation 100 of a method of advertising communication under a preferred embodiment of the invention. The advertisers 60, 62, 64 all transmit their advertising content to the Advertising Service Company 40, which aggregates the content and stores it for later transmission. The ads are served to users visiting the publishers 30, 32, 34. The ACS accumulates an inventory of advertisements from the advertisers. The inventory may be accumulated over time, with ad content received from different publishers at different times.

Service of an advertisement proceeds as noted above, with a user visiting a publisher that has contracted with the ASC to serve ads on the publisher's web page. The ASC may serve any of the ads in the inventory to any given user, but achieves advantages when the advertisement is selected for the particular user. First, the user visiting the publisher site is identified by the cookie that uniquely identifies the user's computer or other communication device used to visit the publisher's site. The cookie is preferably a cookie unique to the ASC, and has been transmitted to the user on the user's first visit to a site associated with the ASC, in conjunction with the user's first receipt of an ad served by the ASC. Although FIG. 2 shows the advertisements being served to publisher's for simplicity and clarity, the advertisements are in fact transmitted by the ASC to users visiting the advertisers.

When the ASC receives the cookie, it then selects the ad best suited to that user. Which ad is best suited is determined based on that user's past activity conducted with the device associated with that cookie. This past activity may normally include web browsing, shopping, and purchasing, and may also include a wide variety of other Internet and electronic communications activities, in addition to non-electronic activity such as conventional commercial transactions. Pre-defined segments generated by the advertiser may be provided to the ASC. Thus, the advertiser may aggregate a wide range and large number of conventional transactions (e.g. point of sale activities, mail orders, telephone orders) to arrive at a segmentation assignment for one or more customers.

The past activity is recorded by the ASC in a database, with the record for the cookie including data of past visits to sites associated with the ASC. For storage and simplicity, instead of including all historical activity of the cookie, the record may include a score that is updated over time, as activity occurs. More frequent visits increase the score, and long intervals between visits allow the score to decay. High value transactions increase the score greatly (perhaps even permanently), while mere visits without purchase increase the score by a smaller increment.

The record for each user/cookie may also include other information provided by the advertiser to the ASC. Such information may be as simple as a list of all cookies of past customers that are considered to be promising prospects to justify advertising investment. This may be based on the advertiser recording the cookies of all site visitors, all site shoppers, all purchasers, and/or other criteria. Members of such a list may be scored based on past activity, or grouped into categories having different positive degrees of promise.

Advertiser selection can be done in many ways: 1) By a likelihood-to-convert score 2) by membership in a specified cookie list (by interest or past actions) and 3) by ad frequency. The advertiser selection may also be based on current activities and information. The ASC notes real time factors such as the time of day, day of the week, the particular site currently being visited, and the type of site being visited. Those who visit at different times may be considered better prospects for different products (e.g. advertising fast food to people browsing before meal times, cars to people browsing before weekends, when most car purchases are made.) The type of site visited may influence advertiser selection. For example, a visitor to sports information publisher may be a particularly good prospect for athletic gear, while a visitor to a financial research site would be a better prospect for banking services or luxury goods. The selection process may consider the user's likelihood to convert, his past actions on the site, and/or combinations of all above these variables and others discussed herein. In addition to selection of advertisers, the above information may be used to select from among different advertisements for the selected advertiser.

In a basic embodiment, the advertiser whose ad is selected by a simple process. First, it is determined if the cookie/user has transacted with any of the advertisers. This is done either by checking whether the cookie is on lists provided by the advertisers, or by examining the ASC database record for the cookie. The record may be formatted to include for each of the ASC's advertiser clients an indicator, either Boolean or having several threshold levels, which indicates whether the cookie has past activities with that advertiser. In the simple instance, if the user is found on only one advertiser's list, or is otherwise determined to have had contact with only one advertiser, that advertiser's advertisement is selected. However, if the user has had recorded contact with two or more advertisers, those advertisers are compared.

To select among the two or more previously-encountered advertisers, the ASC may use any of a wide variety of methods. In any event, the user's past activity is evaluated to determine for which advertiser he or she would be a better prospect. Where past activity with those advertisers is based on a list provided by the advertisers, and those lists are grouped into a hierarchy of levels, with large purchasers typically at the top, the advertiser for which the user has the highest and most recent level is selected. And while the ASC normally provides the service of scoring or evaluating cookies to predict potential value as future customers, the advertisers may opt in an alternative embodiment to submit lists of cookies with a ranking or value scoring (using a common standard such as a 1-10 scale), in which case the higher score advertiser is selected. If the user information is instead derived from the ASC database, similar evaluations are made. In addition to the primary factor of past visits to the possible advertisers, other factors noted above may be used to adjust value scores for the advertisers, to generate a resulting score that is used to make a selection.

If none of the advertisers has had past recorded contact with the user, the selection process uses the past browsing or other activity factors discussed above. For users with no such history, advertisers may be selected based on assumed commonalties with other visitors to the same publisher. For instance, if visitors to Publisher 1 tend to be disproportionately (even if only slightly so) more likely to have had prior contact with Advertiser 2 compared to visitors to the other Publisher's sites, that visitor may be served an ad from Advertiser 2. This approach is based on a process that identifies cookies with above-average surfing attention paid to certain categories of sites. For instance, the top 5% of cookies who surf in each interest category are deemed to have that interest. Cookies are ranked according to both the absolute frequency by which they surfed in an interest and the proportion of all their surfing that went to that interest.

In addition, the aggregation and allocation of advertisements from multiple advertisers and real time can provide benefits to make the ASC's acquisition of advertising space from the publishers on behalf of the advertisers more efficient. If it should be discovered that certain publishers are attracting visits from users with a higher likelihood of having had a past history with at least one of the ASC's advertisers, or users having higher value scores, the ASC can purchase more advertising space from the publisher. This may occur rapidly in response to recorded activity, even with an automated system. The information collected by the ASC is not necessarily known to the publisher, and therefore will not necessarily lead to an increase in the publisher's advertisement prices except for the marginal effect of the increase in demand. This system helps to reduce the significant percentage of advertisement viewers who have no interest in or potential to act upon viewing a given advertisement, conserving advertising dollars and communication resources.

While the above is discussed in terms of preferred and alternative embodiments, the invention is not intended to be so limited.

1. A method of serving Internet advertisements to users having associated cookies comprising:
receiving a cookie from a user visiting a publisher;
retrieving a database record associated with the cookie;
based on the record, selecting a selected advertiser from among a set of advertisers; and
serving an advertisement associated with the selected advertiser to the user.

2. The method of claim 1 including establishing the set of advertisers by contracting with each advertiser in advance to place advertisements.

3. The method of claim 1 wherein retrieving the database record includes retrieving information about past web activity associated with the cookie.

4. The method of claim 1 wherein retrieving the database record includes determining whether the cookie is associated with past interactions with any of the advertisers.

5. The method of claim 4 including, if the cookie has past interactions with more than one of the advertisers, determining a value score for each advertiser.

6. The method of claim 1 wherein selecting an advertiser includes determining a value score for the user with respect to at least a plurality of the advertisers, and selecting the advertiser with the highest score.

7. The method of claim 6 wherein each value score is based at least in part on past interactions of the cookie with the associated advertiser.

8. The method of claim 6 wherein the value score is based on at least a selected one of past purchase activity, past shopping activity, past browsing activity, past advertisements served, current time, current day, user interest category, current site, current page, and current activity type.

9. The method of claim 1 wherein selecting an advertiser includes selecting the advertiser with which the cookie has the highest degree of past activity.

10. The method of claim 9 wherein determining a degree of activity includes establishing a hierarchy of categories of activity, and basing the degree of past activity on the highest category in which activity occurred.

11. A method of serving Internet advertisements to users having associated cookies comprising:
receiving a cookie from a user visiting a publisher;
retrieving a database record of past Internet activity associated with the cookie;
based on the record, determining whether the cookie is associated with past interactions with entities associated with any of the advertisers;
if the cookie has had interactions with entities each associated with a different selected advertiser, serving an advertisement associated with the advertiser with the greatest level of associated interactions.

12. The method of claim 11 wherein the level of associated interactions is based on the number of interactions.

13. The method of claim 11 wherein the level of associated interactions is based on the amount of commercial transactions between the user and the entity.

14. The method of claim 11 wherein if none of the entities with which the cookie has interacted are associated with the advertisers, selecting an advertiser based on the past browsing activity associated with the cookie.

15. The method of claim 11 wherein if only one of advertisers is associated with any of the entities with which the cookie has interacted, serving an advertisement for the one advertiser.
